(19) United States
(12) Patent Application Publication
(10) Pub. No.: US 2010/0178556 A1
(43) Pub. Date: Jul. 15, 2010

(54) Negative electrode for lithium ion battery

(76) Inventors: Veselin Manev, Reno, NV (US); Timothy Spitler, Fernley, NV (US); Matthew Stewart, Reno, NV (US); John Shelburne, Lakeland, FL (US)

Correspondence Address: Altairnano, Inc, 204 Edison Way, Reno, NV, 89502, US

(21) Appl. No.: 12/321,103

(22) Filed: Jan. 15, 2009

(51) Int. Cl. H01M 6/04; H01M 4/62; H01M 4/48; H01B 1/02

(52) U.S. Cl. 429/199; 264/104; 429/217; 429/231.1; 429/231.3; 252/520.21; 252/182.1

(57) ABSTRACT

The methods and devices described herein generally relate to Li₄Ti₅O₁₂ negative electrodes for lithium ion batteries, methods of preparing the Li₄Ti₅O₁₂ negative electrodes, and methods of preparing the lithium ion batteries containing such electrodes. The Li₄Ti₅O₁₂ negative electrode improves the safety performance of the lithium ion battery by preventing or reducing thermal runaway of the lithium ion battery during overcharging.

### BACKGROUND

1. Field

The methods and devices described herein generally relate to Li₄Ti₅O₁₂ negative electrodes for lithium ion batteries, methods of preparing the Li₄Ti₅O₁₂ negative electrodes, and methods of preparing the lithium ion batteries containing such electrodes. The Li₄Ti₅O₁₂ negative electrode improves the safety performance of the lithium ion battery by preventing or reducing thermal runaway of the lithium ion battery during overcharging.

2. Related Art

The majority of portable electronic devices utilize high capacity lithium ion batteries, from small-scale devices such as cellular phones, portable computers, and video cameras, to larger devices such as power tools, hybrid vehicles, construction equipment, and aircraft.

The temperature of a battery or cell is determined by the net heat flow between the heat generated and heat dissipated. Traditional lithium ion batteries exhibit significant problems if operated outside a narrow range of temperatures and voltages. Traditional lithium ion batteries suffer from thermal runaway problems above 130° C. and can be potentially explosive. When traditional lithium ion batteries are heated to 130° C., exothermic chemical reactions between the electrodes and electrolyte occur, raising the cell's internal temperature. If the heat generated is more than can be dissipated, the exothermic processes can rapidly increase. The rise in temperature can further accelerate the chemical reactions, causing even more heat to be produced, eventually resulting in thermal runaway. As the temperature increases accelerate, generated gases in the battery increases the pressure inside the battery. Any pressure generated in this process can cause mechanical failures within cells, triggering short circuits, premature death of the cell, distortion, swelling, and rupture.

Possible exothermic reactions that trigger thermal runaway can include: thermal decomposition of the electrolyte; reduction of the electrolyte by the anode; oxidation of the electrolyte by the cathode; thermal decomposition of the anode and cathode; and melting of the separator and the consequent internal short. Thermal runaway is often a result of abusive conditions, including: overheating, overcharging, high pulse power, physical damage, and internal or external short circuit.

A variety of safety mechanisms such as pressure release valves, one-shot fuses, reversible and irreversible positive temperature coefficient elements, shutdown separators, chemical shuttles, and non-flammable electrolytes and coatings, have been engineered into the batteries to avoid thermal runaway and potential explosion. Furthermore, expensive and sophisticated electronic circuitry is often required to keep cells in charge and voltage balanced.

Despite past engineering efforts, there is still a need for lithium ion batteries that exhibit enhanced safety.

### SUMMARY

The methods and devices described herein generally relate to Li₄Ti₅O₁₂ negative electrodes for lithium ion batteries, methods of preparing the Li₄Ti₅O₁₂ negative electrodes, and methods of preparing the lithium ion batteries containing such electrodes. The Li₄Ti₅O₁₂ negative electrode improves the safety performance of the lithium ion battery by preventing or reducing thermal runaway of the lithium ion battery during overcharging. In one exemplary variation, the negative electrode material includes a plurality of Li₄Ti₅O₁₂-based particles, each particle of the plurality of particles including a plurality of Li₄Ti₅O₁₂ crystallites. The particles have an average diameter from 1 to 15 microns, and the crystallites have an average diameter from 20 to 80 nanometers. The negative electrode material also includes a plurality of pores formed as spaces between the plurality of Li₄Ti₅O₁₂ crystallites. The electrode material pores have an average diameter from 10 to 60 nanometers, and the electrode material exhibits a porosity in the range of 20 to 50%.

### DESCRIPTION OF DRAWING FIGURES

FIG. 1 is a SEM (Scanning Electron Microscope) image of a cross section of a Li₄Ti₅O₁₂ electrode with an average pore diameter of 20 nanometers prepared from Li₄Ti₅O₁₂ electrode material with an average particle diameter of 10 microns and an average crystallite diameter of 40 nanometers. After compaction, the electrode film has a nearly homogenous structure without significant porosity between the particles. Thus, the overall electrode porosity is controlled by the porosity of the particles themselves rather than porosity between the particles.

FIG. 2 is a graph of the electrode pore size distribution of two Li₄Ti₅O₁₂ electrodes of different densities, 1.8 and 2.1 g/cc, prepared from Li₄Ti₅O₁₂ with an average crystallite diameter of 40 nanometers. The electrode with the higher density of 2.1 g/cc has an average pore diameter of 20 nanometers, and the electrode with the lower density of 1.8 g/cc has an average pore diameter of 30 nanometers. The pore size distribution was measured on the negative electrode by a nitrogen adsorption technique.

FIG. 3 is a graph showing results of an overcharge test of a cell with a Li₄Ti₅O₁₂ negative electrode with an average electrode pore diameter of 30 nanometers and an electrode density of 1.8 g/cc. The positive electrode used for this test was LiCoO₂, and the cell voltage limits during regular cycling tests were 1.5 V to 2.8 V. The overcharge test is performed at 3C charge rate and 10 V.

FIG. 4 is a graph showing results of an overcharge test of a cell with a Li₄Ti₅O₁₂ negative electrode with an average electrode pore diameter of 20 nanometers and an electrode density of 2.1 g/cc. The positive electrode used for this test was LiCoO₂, and the cell voltage limits during regular cycling tests were 1.5 V to 2.8 V. The overcharge test is performed at 3C charge rate and 10 V.

### DETAILED DESCRIPTION

In order to provide a more thorough understanding of the methods and devices described herein, the following description sets forth numerous specific details, such as methods, parameters, examples, and the like. It should be recognized, however, that such description is not intended as a limitation on the scope of the methods and devices described herein, but rather is intended to provide a better understanding of the possible variations.

### Definitions

The terms “calendar, calendared, calendaring, compaction, compacted, or compacting” refer to drawing a material between two rollers at a given pressure.

The terms “crystallite or crystallites” refer to an object or objects of solid state matter that have the same structure as a single crystal. Solid state materials may be composed of aggregates of crystallites which form larger objects of solid state matter such as particles.

The methods and devices described herein generally relate to Li₄Ti₅O₁₂ negative electrodes for lithium ion batteries, methods of preparing the Li₄Ti₅O₁₂ negative electrodes, and methods of preparing the lithium ion batteries containing such electrodes. The Li₄Ti₅O₁₂ negative electrode improves the safety performance of the lithium ion battery by preventing or reducing thermal runaway of the lithium ion battery during overcharging.

### Negative Electrode Material

The negative electrode may include a negative electrode material. The negative electrode material may include a plurality of Li₄Ti₅O₁₂-based particles. The particles may have an average diameter from 1 to 15 microns. In some variations, the particles may have an average diameter of 1, 2, 3, 4, 5, 6, 7, 8, 9, 10, 11, 12, 13, 14, or 15 microns. Each particle of the plurality of particles may include a plurality of Li₄Ti₅O₁₂ crystallites. The crystallites may have an average diameter from 20 to 80 nanometers. The negative electrode material may also include a plurality of pores formed as spaces between the plurality of Li₄Ti₅O₁₂ crystallites. The electrode material pores may have an average diameter from 10 to 60 nanometers. The electrode material porosity may range from 20 to 50%.

### Finished Negative Electrode

Once the Li₄Ti₅O₁₂ negative electrode material with the desired properties is selected, a negative electrode may be prepared by calendaring or compacting the Li₄Ti₅O₁₂ negative electrode material described above and a binder. Alternatively, a negative electrode may be prepared by calendaring or compacting the Li₄Ti₅O₁₂ negative electrode material, a binder, and a conductive agent. A binder can be a polymeric binder. In one variation, the binder may be polyvinylidene fluoride, and the conductive agent may be carbon black. The conductive agent can be any agent that serves to improve the electrical conductivity of the electrode. After compaction, the electrode material pore size and porosity may control the electrode pore size and porosity. The electrode pore size and porosity may be the same or different than the electrode material pore size and porosity. The electrode pores may have an average diameter from 10 to 60 nanometers. In some variations, the electrode pores may have an average diameter of 10, 15, 20, 25, 30, 35, 40, 45, 50, 55, or 60 nanometers. The electrode porosity may range from 20 to 50%. In some variations, the electrode porosity may be 20, 25, 30, 35, 40, 45, or 50%. As described herein, electrode average pore diameters and porosities in these ranges have been found to prevent or reduce thermal runaway in a lithium ion battery containing the electrode if the battery is overcharged.

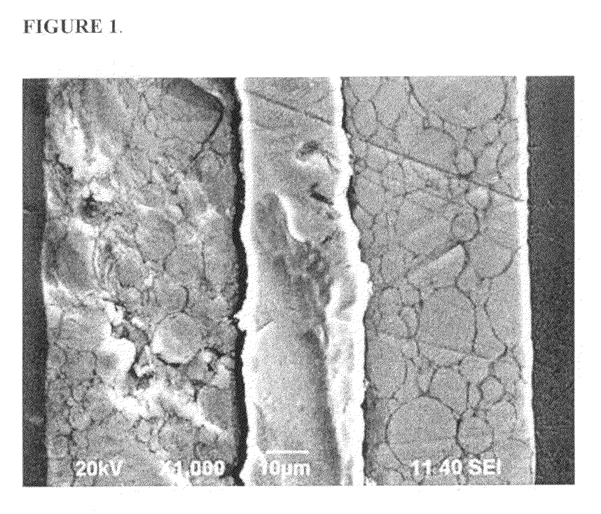

The negative electrode, once prepared by compaction, has a nearly homogeneous structure without significant porosity between the particles as shown in FIG. 1. Thus, the overall negative electrode porosity may be controlled by the pores of the particles themselves (between the crystallites) rather than pores between the particles. After compaction, the total volume of the pores of the particles in any given volume of the electrode may contribute to 80, 85, 90, 95, or 100% of the electrode porosity. In embodiments in which the pores of the particles do not contribute to 100% of the electrode porosity, the remaining porosity is substantially formed by the pores between the particles.

The electrode material crystallite size may control the electrode material pore size and/or the electrode pore size. Typically, the average electrode pore size is lower than the average electrode material crystallite size by a factor of 1.5 to 2. For example, electrode material crystallites may have an average diameter of 80 nanometers, and an electrode made from this electrode material may have an average electrode pore diameter in the range of 40 to 60 nanometers. In another variation, electrode material crystallites may have an average diameter of 40 nanometers, an electrode made from this electrode material may have an average electrode pore diameter in the range of 20 to 30 nanometers.

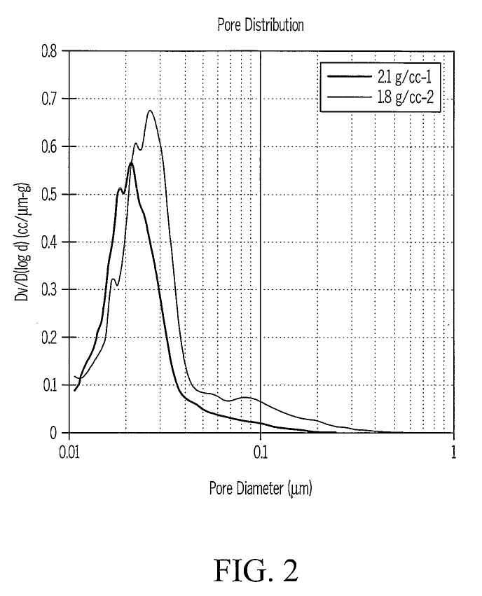

The electrode pores may also be controlled by the density of the finished electrode. The different densities are a result of the degree of compaction of the electrode material and binder or the degree of compaction of the electrode material, binder, and conductive agent during electrode preparation. The pore size distribution of two negative electrodes of different densities (1.8 and 2.1 g/cc) each made from Li₄Ti₅O₁₂ starting material with 40 nanometer crystallites is shown in FIG. 2. The negative electrode with the higher density of 2.1 g/cc has an average pore diameter of 20 nanometers, and the negative electrode with the lower density of 1.8 g/cc has an average pore diameter of 30 nanometers. In some variations, the negative electrode density may be 1.6 to 2.2 g/cc. In some variations, the negative electrode density may be 1.6, 1.8, 2.0, or 2.2 g/cc.

### Batteries

In some variations, the Li₄Ti₅O₁₂ negative electrode material may be used in a lithium ion battery. In some variations, the Li₄Ti₅O₁₂ negative electrode prepared with the Li₄Ti₅O₁₂ negative electrode material and a binder may be used in a lithium ion battery. In some variations, the Li₄Ti₅O₁₂ negative electrode prepared with Li₄Ti₅O₁₂ negative electrode material, a binder, and a conductive agent may be used in a lithium ion battery. The binder may be poly-vinylidene fluoride and the conductive agent may be carbon black. Typically, the battery does not undergo thermal runaway if the battery is overcharged. Overcharge protection depends on the average pore diameter of the negative electrode which depends on the average crystallite diameter and the average particle diameter of the Li₄Ti₅O₁₂ starting material. If the average pore diameter of the negative electrode is greater than 100 nanometers, the overcharge protection may be lost and the battery may undergo thermal runaway.

In some variations, the lithium ion battery includes a Li₄Ti₅O₁₂ negative electrode and a positive electrode. The positive electrode may be composed of LiCoO₂ or LiMn₂O₄. The negative electrode and the positive electrode of the lithium ion battery each have a capacity. The capacity of the negative electrode may be lower than the capacity of the positive electrode. The ratio of the negative electrode capacity to the positive electrode capacity may be less than 1.

In some variations, the lithium ion battery includes an electrolyte which may be composed of a solvent or mixture of solvents and a lithium salt or mixture of lithium salts. Examples of solvents which may be used include ethylene carbonate (EC), ethylene methyl carbonate (EMC), propylene carbonate (PC), butylene carbonate (BC), vinylene carbonate (VC), diethylene carbonate (DEC), dimethylene carbonate (DMC), γ-butyrolactone, sulfolane, methyl acetate (MA), methyl propionate (MP), and methylformate (MF). Examples of lithium salts include LiBF₄, LiPF₆, LiAsF₆, LiClO₄, LiSbF₆, LiCF₃SO₃, and LiN(CF₃ SO₂)₂. In some variations, the electrolyte may include mixtures of ethylene carbonate, ethylene methyl carbonate, and LiPF₆.

### Methods

The methods described herein provide a method for preparing a negative electrode for a lithium ion battery. The method includes calendaring a negative electrode composition which may include a negative electrode material at a pressure such that the negative electrode exhibits an electrode density ranging from 1.6 to 2.2 g/cc and an electrode porosity in the range of 20 to 50%. The negative electrode material may include the Li₄Ti₅O₁₂ electrode material described above. In some variations, the negative electrode composition may include a binder. In some variations, the negative electrode composition may include a binder and a conductive agent. The binder may be poly-vinylidene fluoride and the conductive agent may be carbon black.

The methods described herein provide a method of preparing a lithium ion battery. The method includes a) assembling a positive electrode and a negative electrode inside a container; b) adding an electrolyte to the container; and c) sealing the container to form the lithium ion battery. The assembled negative electrode and positive electrode may each have a capacity. The negative electrode capacity may be lower than the positive electrode capacity. The ratio of the negative electrode capacity to the positive electrode capacity may be less than one. The negative electrode may be prepared by calendaring a negative electrode material and a binder. Alternatively, the negative electrode may be prepared by calendaring a negative electrode material, a binder, and a conductive agent. The binder may be poly-vinylidene fluoride and the conductive agent may be carbon black. The negative electrode material may include the Li₄Ti₅O₁₂ electrode material described above. In some variations, after calendaring, the negative electrode pores may have an average diameter from 10 to 60 nanometers. In some variations, after calendaring, the negative electrode porosity may range from 20 to 50%.

### EXAMPLE 1

Li₄Ti₅O₁₂ was prepared as described in U.S. Pat. No. 6,890,510. The negative electrode was formed using the following steps: mixing Li₄Ti₅O₁₂ with 5% carbon black and 5% Polyvinylidene Fluoride (PVDF) binder dissolved in N-Methyl-2-pyrrolidone (NMP) solvent to form a slurry; the slurry was spread on both sides of an aluminum foil current collector and heated to evaporate the NMP solvent; the dry electrode was calendared (compacted) and cut into a rectangular sample electrodes.

The positive electrode was prepared with LiCoO₂ instead of Li₄Ti₅O₁₂ using the same procedure described for preparation of the negative electrode.

The two prepared electrodes were placed inside a soft pack electrochemical cell with EC:EMC/LiPF₆ electrolyte.

### EXAMPLE 2

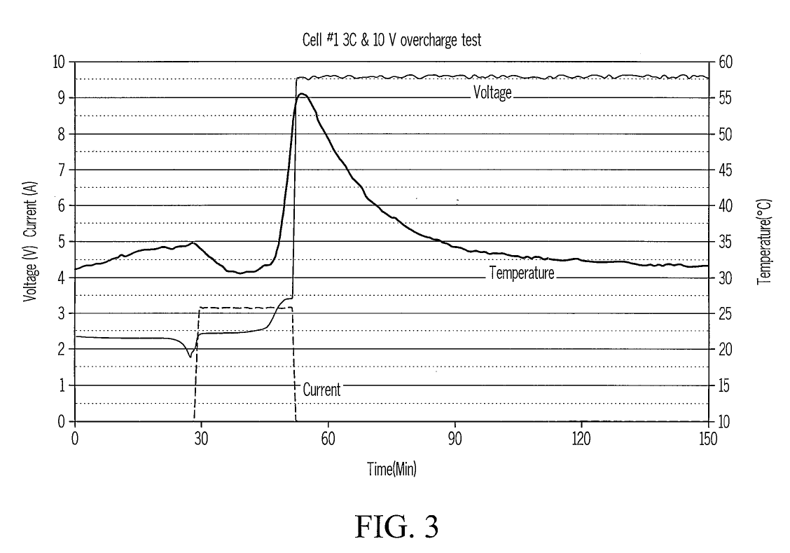

An electrochemical cell was prepared as described in Example 1. The density of the Li₄Ti₅O₁₂ negative electrode was 1.8 g/cc, and the average pore diameter of the electrode was 30 nanometers. The cell voltage limit was determined to be 1.5 V to 2.8 V in a regular charge-discharge cycling test. An overcharge test was performed at a 3C charge rate at 10 V. The results are presented in FIG. 3. During the overcharge test, the cell voltage reached a plateau of 3.4 V and several minutes later, the current abruptly decreased to zero, and the cell voltage increased to 10 V. After the increase of cell voltage from its upper voltage limit (2.8 V), the cell temperature started to increase, but at the point where the voltage increased to 10 V and the current decreased to zero, the cell temperature reached 56° C. at its maximum and gradually decreased. This shows that thermal runaway did not take place during this test.

### EXAMPLE 3

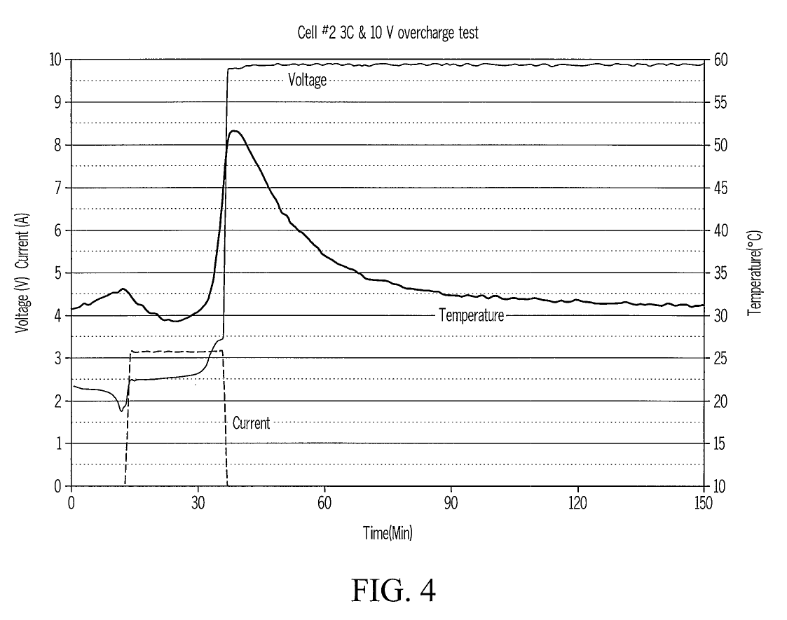

An electrochemical cell was prepared as described in Example 1. The density of the Li₄Ti₅O₁₂ negative electrode was 2.1 g/cc, and the average pore diameter of the electrode was 20 nanometers. The cell voltage limit was determined to be 1.5 V to 2.8 V in a regular charge-discharge cycling test. An overcharge test was performed at a 3C charge rate at 10 V. The results are presented in FIG. 4. During the overcharge test, the cell voltage reached a plateau of 3.4 V and several minutes later, the current abruptly decreased to zero, and the cell voltage increased to 10 V. After the increase of cell voltage from its upper voltage limit (2.8 V), the cell temperature started to increase, but at the point where the voltage increased to 10 V and the current decreased to zero, the cell temperature reached 52° C. at its maximum and gradually decreased. This shows that thermal runaway did not take place during this test.

Although the methods and devices described herein have been described in connection with some embodiments or variations, it is not intended to be limited to the specific form set forth herein. Rather, the scope of the methods and devices described herein is limited only by the claims. Additionally, although a feature may appear to be described in connection with particular embodiments or variations, one skilled in the art would recognize that various features of the described embodiments or variations may be combined in accordance with the methods and devices described herein.

Furthermore, although individually listed, a plurality of means, elements or method steps may be implemented by, for example, a single devices or method. Additionally, although individual features may be included in different claims, these may be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof, unless otherwise expressly stated, should be construed as open ended as opposed to limiting. As examples of the foregoing: the term “including” should be read to mean “including, without limitation” or the like; the terms “example” or “some variations” are used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of methods and devices described herein may be described or claimed in the singular, the plural is contemplated to be within the scope thereof unless limitation to the singular is explicitly stated. The presence of broadening words and phrases such as “one or more,” “at least,” “but not limited to,” “in some variations” or other like phrases in some instances shall not be read to mean that the narrower case is intended or required in instances where such broadening phrases may be absent.

1. A negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the electrode material exhibits a porosity in the range of 20 to 50%.

2. The negative electrode material of claim 1, wherein the particles have an average diameter from 2 to 10 microns.

3. The negative electrode material of claim 2, wherein the pores have an average diameter from 15 to 40 nanometers and the porosity is in the range of 30 to 45%.

4. A negative electrode comprising:
a binder; and
a negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the negative electrode exhibits a porosity in the range of 20 to 50%.

5. The negative electrode of claim 4, wherein the particles have an average diameter from 2 to 10 microns.

6. The negative electrode of claim 5, wherein the pores have an average diameter from 15 to 40 nanometers, and wherein the negative electrode exhibits a porosity in the range of 30 to 45%.

7. The negative electrode of claim 4, further comprising a conductive agent.

8. The negative electrode of claim 7, wherein the binder is poly-vinylidene fluoride and the conductive agent is carbon black.

9. The negative electrode of claim 8, further comprising an aluminum foil current collector.

10. The negative electrode of claim 4, wherein the negative electrode has a density, and wherein the density ranges from 1.6 to 2.2 g/cc.

11. A lithium ion battery comprising a negative electrode material, the negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the electrode material exhibits a porosity in the range of 20 to 50%.

12. A lithium ion battery comprising:
a positive electrode; and
a negative electrode, wherein the negative electrode has a negative electrode capacity and the positive electrode has a positive electrode capacity, and wherein a ratio of the negative electrode capacity to the positive electrode capacity is less than one, the negative electrode comprising:
a binder; and
a negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the negative electrode exhibits a porosity in the range of 20 to 50%.

13. The lithium ion battery of claim 12, wherein the ratio ranges from 0.5 to 0.95.

14. The lithium ion battery of claim 12, wherein the pores have an average diameter from 15 to 40 nanometers, and wherein the negative electrode exhibits a porosity in the range of 30 to 45%.

15. The lithium ion battery of claim 12, wherein the positive electrode comprises LiCoO₂.

16. The lithium ion battery of claim 15, wherein the negative electrode has a density, and wherein the density ranges from 1.6 to 2.2 g/cc.

17. The lithium ion battery of claim 12, further comprising an electrolyte, wherein the electrolyte comprises a mixture of ethylene carbonate, ethylene methyl carbonate, and LiPF₆.

18. The lithium ion battery of claim 12, wherein the negative electrode further comprises a conductive agent.

19. The lithium ion battery of claim 18, wherein the binder is poly-vinylidene fluoride and the conductive agent is carbon black.

20. A method of preparing a negative electrode for a lithium ion battery comprising calendaring a negative electrode composition comprising a negative electrode material at a pressure such that the negative electrode exhibits an electrode density ranging from 1.6 to 2.2 g/cc and an electrode porosity in the range of 20 to 50%, the negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the electrode material exhibits a porosity in the range of 20 to 50%.

21. The method of claim 20, wherein the negative electrode composition further comprises a binder and a conductive agent.

22. The method of claim 21, wherein the binder is poly-vinylidene fluoride and the conductive agent is carbon black.

23. The method of claim 20, wherein the negative electrode exhibits an electrode porosity in the range of 30 to 45%.

24. A method of preparing a lithium ion battery comprising:
a) assembling a positive electrode and a negative electrode inside a container;
b) adding an electrolyte to the container; and
c) sealing the container to form the lithium ion battery;
wherein the negative electrode has a negative electrode capacity and the positive electrode has a positive electrode capacity, wherein a ratio of the negative electrode capacity to the positive electrode capacity is less than one, and wherein the negative electrode comprises:
a binder; and
a negative electrode material comprising:
a plurality of Li₄Ti₅O₁₂-based particles, each particle of the plurality of particles comprising:
a plurality of Li₄Ti₅O₁₂ crystallites, wherein the crystallites have an average diameter from 20 to 80 nanometers; and
a plurality of pores formed as spaces between the plurality of Li₄Ti₅O₁₂ crystallites, wherein the pores have an average diameter from 10 to 60 nanometers; and
wherein the particles have an average diameter from 1 to 15 microns, and wherein the negative electrode exhibits a porosity in the range of 20 to 50%.

25. The method of claim 24, wherein the ratio ranges from 0.5 to 0.95.

26. The method of claim 24, wherein the positive electrode comprises LiCoO₂.

27. The method of claim 24, wherein the electrolyte comprises a mixture of ethylene carbonate, ethylene methyl carbonate, and LiPF₆.

28. The method of claim 24, wherein the negative electrode further comprises a conductive agent.

29. The method of claim 28, wherein the binder is poly-vinylidene fluoride and the conductive agent is carbon black.
